(19) United States
(12) Patent Application Publication
(10) Pub. No.: US 2017/0091263 A1
(43) Pub. Date: Mar. 30, 2017

(54) EVENT-BASED ENTITY AND OBJECT CREATION

(71) Applicant: Google Inc., Mountain View, CA (US)

(72) Inventors: Dan FREDINBURG, San Francisco, CA (US); Andrew Cary Swerdlow, San Francisco, CA (US)

(73) Assignee: Google Inc., Mountain View, CA (US)

(21) Appl. No.: 14/063,990

(22) Filed: Oct. 25, 2013

Related U.S. Application Data
(60) Provisional application No. 61/720,948, filed on Oct. 31, 2012.

(51) Int. Cl. G06F 17/30

(52) U.S. Cl. CPC G06F 17/30386

(57) ABSTRACT

The subject matter of this specification can be implemented in, among other things, a method for providing content suggestions based on an event. The method includes a step for receiving event metadata. The method also includes a step for retrieving interest profiles for a plurality of attendees or invitees from the list of attendees or invitees. The method also includes a step for determining attributes for the event based on the received event metadata. The method also includes a step for determining content suggestions based on the retrieved interest profiles and the determined attributes. The method also includes a step for providing one or more of the determined content suggestions for a user to manage the event.

### CROSS-REFERENCE TO RELATED APPLICATIONS

The present application claims the benefit of priority under 35 U.S.C. §119 from U.S. Provisional Patent Application Ser. No. 61/720,948, filed on Oct. 31, 2012, the disclosure of which is hereby incorporated by reference in its entirety for all purposes.

### BACKGROUND

The subject technology generally relates to social networking and, in particular, relates to event-based entity and object creation.

Users may create events for recreation, business, education, and family gatherings. During an event creation process, users may provide data such as the subject, description, a list of invitees/ attendees, attachments, and themes for the event. In some cases, event creation is a manual process where the user creating the event provides most of the input required to generate the event.

### SUMMARY

The disclosed subject matter relates to a method for making content suggestions or recommendations based on an event. In one aspect, the method includes a step for receiving event metadata. The method also includes a step for retrieving interest profiles for a plurality of attendees or invitees from the list of attendees or invitees. The method also includes a step for determining attributes for the event based on the received event metadata. The method also includes a step for determining content suggestions based on the retrieved interest profiles and the determined attributes. The method also includes a step for providing one or more of the determined content suggestions for a user to manage the event. Other aspects include corresponding systems, apparatus, and computer program products.

These and other aspects can include one or more of the following features. The event metadata may include a subject, a description, and a list of attendees or invitees for the event. User profiles may also be retrieved for the plurality of attendees or invitees from the list of the attendees and used in determining content suggestions. One or more determined content suggestions may be used to construct an agenda or a newsletter for the event and provided for the user as a suggestion for the event. The determined content suggestions may include an event theme to use for the event, or content items to share for the event. The method may also include as step for receiving approval, disapproval, or modification of the one or more provided content suggestions. The event may be updated based on the received approval, disapproval, or modification.

The disclosed subject matter further relates to a non-transitory computer-readable medium. The computer-readable medium includes instructions that, when executed by a computer, cause the computer to implement a method for providing suggestions or recommendations based on an event. The instructions include code for receiving event metadata. The instructions also include code for retrieving user profiles and interest profiles for a plurality of attendees or invitees from the list of attendees or invitees. The instructions also include code for determining attributes for the event based on the received event metadata. The instructions also include code for determining content suggestions based on the retrieved user profiles and interest profiles and the determined attributes. The instructions also include code for providing one or more of the determined content suggestions for a user to manage the event. Other aspects can include corresponding systems, apparatus and computer program products.

The disclosed subject matter further relates to a system. The system includes one or more processors. The system also includes a memory, the memory having instructions which, when executed by the one or more processors, cause the one or more processors to implement a method for providing content suggestions based on an event. The instructions include code receiving event metadata. The instructions also include code for determining attributes for the event based on the received event metadata. The instructions also include code for determining content suggestions based on the determined attributes. The instructions also include code for providing one or more of the determined content suggestions for a user to manage the event. Other aspects can include corresponding systems, apparatus and computer program products.

Advantageously, the subject technology allows for data about an event or data about invitees or attendees of the event to be used in planning the event. For example, if an event creator is planning a family Christmas event in Houston and the invitees of the event are interested in sushi and American football, an American football game in Houston or a sushi restaurant in Houston may be suggested as components of the event. The event creator may then approve or modify the American football game or the sushi restaurant being added to an agenda for the event.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1 illustrates an example data flow diagram for event-based entity and object creation.

FIG. 2 illustrates an example of a system for event-based entity and object creation.

FIG. 3 illustrates an example of the data repository of FIG. 2.

FIG. 4 illustrates an example of the server of FIG. 2.

FIG. 5 illustrates an example process by which event-based entities and objects may be created.

FIG. 6 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent that the subject technology is not limited to the specific details set forth herein and may be practiced without these specific details. In some instances, structures and components are shown in block diagram form in order to avoid obscuring the concepts of the subject technology.

The subject technology provides techniques for assisting a user in event creation and modification. In some aspects, event metadata (e.g., subject, description, list of invitees/attendees, attachments, and any other data provided during an event creation process) provided by an event creator, along with interest profiles of the invitees/attendees for the event, is analyzed to provide suggestions for the event.

In one aspect, an agenda for an event is suggested based on the event metadata and interest profiles of the invitees/attendees. For example, a user may be creating an event for Christmas in Houston for the user's family. Based on the metadata provided by the user (e.g., “Christmas”, “Houston”, list of family members invited to the event, etc.), an agenda may be suggested for the Christmas event. Authorized analysis of the family member's profiles may indicate an interest in American football. If an activities database is queried for “American football” events, and a football game event shows up for the same time as the created event or the dates of the event, then the football game may be provided as a suggestion for the agenda.

As another example, if a family member's profile indicates a preference for sushi, then several sushi restaurants in the Houston area may be recommended for the agenda. In some aspects, recommendations are based on a threshold number or percentage of members indicating an interest in a particular item (e.g., in the above example, 18 out of 20 family members indicate a liking for American football, or 16 out of 20 family members indicate a liking for sushi). Recommendations may be based on the strength of interest indicated by a particular member's profile for the item (e.g., in the above example, 10 out of 20 family members indicate a strong liking for American football, or 11 out of 20 family members indicate a strong preference for sushi). Strong preference may be determined based on an individual's profile and web usage history (e.g., how many times a user frequents a sushi restaurant, or searches for sushi related items, or endorses sushi related items, etc.)

In one aspect, a newsletter for an event is suggested based on the event metadata and interest profiles of the invitees/attendees. For example, if an event for Hypertext Preprocessor (PHP) programming is being created for programmers and other invitees/attendees, then keywords from the supplied metadata (e.g., title of the event may be “PHP programmers conference”, description may contain the words “PHP” and “programmers”, etc.) may be used to suggest a newsletter to provide for the event. A news repository or opinions repository may be queried for content (e.g., articles, op-eds, etc.) using the keywords from the event metadata to construct a newsletter as a suggestion for the event.

Interest profiles of the invitees/attendees may also be used to determine a list of topics for which to query news or opinion repositories for content. For example, if a certain percentage of invitees/attendees indicate a preference for “gaming”, then articles may be searched that relate to “gaming” and suggested in a news letter for the event. A list of content items from the search of news or opinions repositories may be presented in a time-relevant newsletter for the invitees/attendees consumption. A creator or administrator of the event may accept, modify and then accept, or not accept a proposed newsletter.

In some aspects, content items (e.g., photos, articles, other documents) to provide with the event are suggested based on the event metadata and interest profiles of the invitees/attendees. In some aspects, keywords are determined based on the event metadata, and various document repositories are queried using the keywords to suggest documents or other content items to provide for the event. The keywords may be indicative of topics of interest to the invitees/attendees, and databases keyed to those topics may be queried to retrieve content items for suggestion for the event.

In some aspects, an event theme (e.g., picture, music, etc.) is suggested based on the event metadata and interest profiles of the invitees/attendees. For example, a picnic event for a family that indicates a liking for impressionist art may suggest a Renoir painting image as the background for the event theme. An event theme repository may be queried to select themes based on the keywords from the event metadata or based on interests of the event's invitees/attendees.

The event creator may opt to accept or modify suggestions (e.g., add, delete, or change parts of any suggesting item).

In other aspects, event metadata and interest profiles of the invitees/attendees of the event are analyzed to suggest a group of contacts for various purposes (e.g., mailing list, future group list for events, a social circle in a social networking service, etc.).

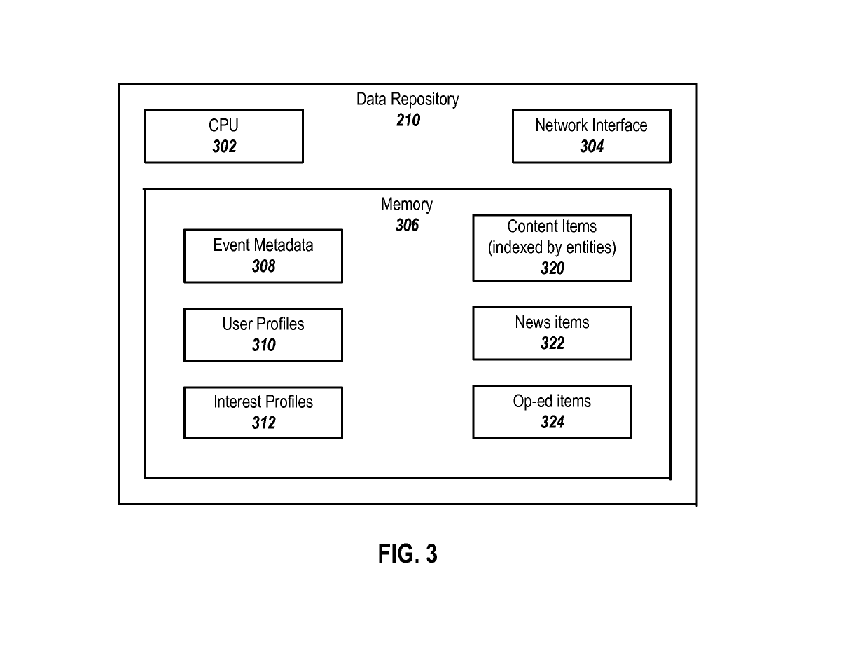

In other aspects, event metadata is analyzed to create an entity. As used herein, an “entity” can include an instance of something (e.g., a subject, topic, or interest such as those provided in the examples above: American Football, sushi, etc.) that can then be used to query repositories for content items related to an entity. (See the description below for FIG. 3 for more details on entities). For example, if the event metadata has keywords including “Company X Java Conference” then an entity for “Company X Java Conference” may be created as a new entity, e.g., where it did not exist prior to the analysis. The created entity may be used by other applications (e.g., search engines, etc.), in addition to suggestions for event creation as described herein, to query content items related to the entity.

A newsletter module of the subject technology can provide for the most relevant articles based on the topics of interest of the attendees or invitees, the topic of the event, etc. In some aspects, if a major event (e.g., a Java programming conference by a company X) is created as an entity, the major event can be stored in a data repository in conjunction with the topic (e.g., Java programming).

Some aspects of the subject technology include, among other things, storing and accessing information about a user (e.g., a user's interests, a user's status as an invitee or attendee of an event, etc.) for the purpose of planning event(s). The user affirmatively opts in to having his/her information stored or the user can opt-out of having his/her information stored. Furthermore, the user may be provided reminders that his/her information is being stored or used for the purpose of planning event(s). The user may be provided with such reminders when he/she logs into the event planning or social networking service, every n log-ins to the event planning or social networking service (e.g., every ten log-ins or every twenty log-ins), every n days (e.g., every thirty days or every fourteen days), or by electronic message (e.g., email or text message) every n days (e.g., every seven days or every sixty days). The user can remove any information stored about him/her by the social networking or event planning service at any time.

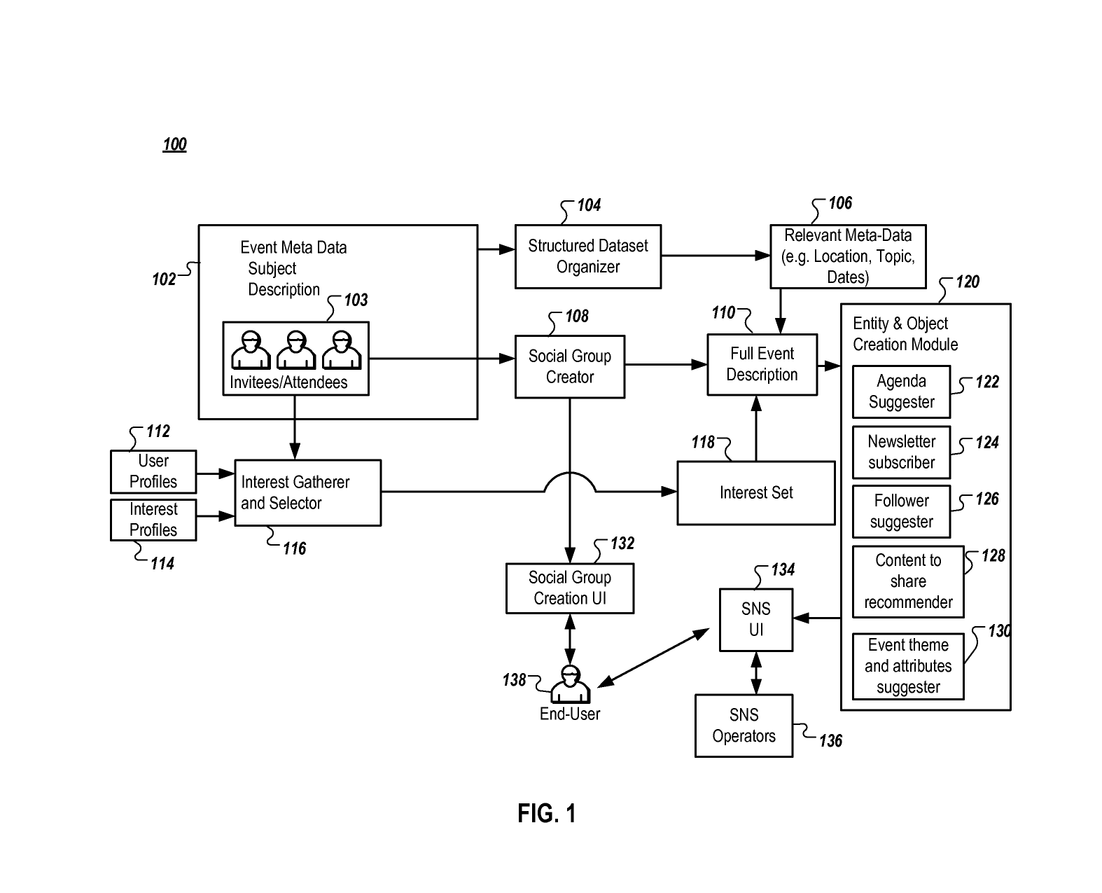

FIG. 1 illustrates an example data flow diagram 100 for event-based entity and object creation.

As shown, some branches of the data flow diagram 100 begin at event metadata 102. The event metadata 102 includes an event subject, an event description, and a set of invitees/attendees 103. The event subject may be any subject for an event, for example, “Sally's birthday party,” “Family Christmas celebration,” or “Company X Java Conference.” The event description may include a more detailed description of the event, for example, a few paragraphs in length. However, the event description may be of any length. Some events may lack an event description. The set of invitees 103 may include invitees identified by username in a social networking service or by electronic messaging (e.g., email) address. The event metadata 102 may be entered by a user creating the event or by another user who is permitted to edit the event metadata 102 by the user creating the event.

According to some branches of the data flow diagram 100, the event metadata 102 is provided to a structured dataset organizer 104. The structured dataset organizer determines relevant metadata 106 from the event metadata 102. For example, an event may be titled “Family Christmas celebration.” The event description may mention that the event will take place in Houston, from Dec. 22, 2012 to Dec. 26, 2012, and that the attendees expect to visit historic sites in the city. Based on this event metadata 102, relevant metadata may include that the event is located in Houston. Topics associated with the event may include “family,” “Christmas,” or “historic sites.” The dates of the event may be set to a start date of Dec. 22, 2012 and an end date of Dec. 26, 2012. The relevant metadata 106 is stored, among other information, in a full event description 110 for the event.

According to some branches of the data flow diagram 100, the set of invitees 103 is provided to a social group creator module 108. The social group creator module 108 is configured to create a social group (e.g., a symmetric social group that is the same for multiple viewing members (e.g., a college alumni group or a group of members in a club) or an asymmetric social group that is only visible to one viewing member for the purpose of organizing the social contacts of the viewing member (e.g., a viewing member may have separate asymmetric social groups for family, friends, and co-workers and may share different information with each). The social group creator module 108 provides information to a social group creation user interface 132, allowing for the social group to be approved or disapproved by an end-user 138 (e.g., an end-user creating the event). The social group creation user interface 132 may allow the end-user 138 to modify members of the suggested social group prior to approval or disapproval of the social group. The social group creator module 108 may also provide data to be stored, among other information, in the full event description 110.

According to some branches of the data flow diagram 100, an interest gatherer and selector module 116 obtains user profiles 112 (e.g. user profiles in a social networking service) and interest profiles 114 (e.g., a list of interests of a user as provided by the user to the social networking service or determined by the social networking service based on the interaction of the user with the social networking service or determined by web usage history of the user or members of social groups of the user) of the invitees 103 in the event metadata 102. The interest gatherer and selector 116 generates an interest set 118 associated with the invitees 103. Interests of a user (e.g., an invitee 103) may be specified by the user (e.g., the user affirmatively notifies the social networking service that he/she is interested in basketball) or may be determined based on a user's interaction with the social networking service (e.g., a user is likely to be interested in basketball if the user creates posts about basketball or the user views or interacts with content related to basketball in the social networking service). Interests of a user may also be based on a web usage history of the user or members of social groups of the user (e.g., search history of the user or friends of the user, endorsements of the user in a social networking site, etc.)

The interest set 118 may include interests that are held by at least a threshold number (e.g., five) or a threshold proportion (e.g., 50%) of the invitees 103. In some aspects, an interest level of an invitee 103 for an interest may be determined by the interest gatherer and selector 116, and stronger interests (e.g., interests having higher interest levels) may be added to the interest set if the stronger interests are shared by a lower threshold number (e.g., three rather than five) or a lower threshold proportion (e.g., 35% rather than 50%) of the invitees 103. For example, a user who makes one post per week about basketball has a less strong interest in basketball than a user who indicated that he/she is a member of a basketball club and makes three posts per week about basketball.

The full event description 110 receives information from the relevant metadata 106, the social group creator 108, and the interest set 118. The full event description 110 is provided to the entity and object creation module 120. The entity and object creation module 120 includes an agenda suggester 122, a newsletter subscriber 124, a follower suggestion 126, a content to share suggester 128, and an event theme and attribute suggester 130.

The agenda suggester 122 suggests an agenda for the event. The agenda may include items based on the relevant metadata or based on the interest set. For example, an event titled “Family Christmas celebration” taking place in Houston may include a time for opening gifts based on the fact that a holiday when gifts are exchanged is celebrated. If invitees to the event or attendees of the event are interested in American football, the agenda may include a trip to see an American football game or watching an American football game on television. The creator of the event approves of any items in the agenda before they are added to the agenda. Agenda items to suggest may be determined by querying data repositories for content items, keyed by entities (e.g., searching for “American football” provides a American football game event airing on television or happening in Houston at the time of the event, searching for “Christmas” provides an opening gifts event for the day of Christmas, etc.)

The newsletter subscriber 124 creates a newsletter for the event. The newsletter is provided to attendees or invitees of the event. The newsletter may include information relevant to the event. For example, if the event is titled “Java programming conference,” the newsletter can include content items (e.g., articles, posts in a social networking service, etc.) related to Java programming. The content items may be retrieved by querying a data repositories of content items, keyed by entities (e.g., searching for “Java programming conference” may provide a list of articles, posts, op-eds, etc. related to those keywords). Users other than the attendees or invitees may subscribe to the created newsletter. For example, the newsletter may be made available to various users of a social networking service based on the user's profiles or interest profiles. The respective users may then either accept subscription to the newsletter or may deny subscription to the newsletter.

The follower suggestions 126 suggest followers for the event. A user may follow an event, for example, if the user is interested in the topic(s) of the event but cannot attend the event. For example, a Java programmer who is interested in the topics described in the event titled “Java programming conference,” but cannot attend the event may follow the event to receive the relevant newsletter and be provided with information about the topic(s) or updates or developments (e.g., audio or video recordings of speakers, etc.) of the event. Suggestion to follow the event may be made to a plurality of users, e.g., users of a social networking service based on their respective interest profiles. Users that are provided with a suggestion to follow the event may opt to either follow or not follow the event upon the suggestion.

The content to share recommender 128 recommends content to be shared in association with the event, for example, in a page of the event in the social networking service. The content may be selected based on the information provided in the full event description 110. For example, the event may be a picnic with several invitees who are interested in impressionist art. As a result, the content to share recommender 128 may recommend that an impressionist painting of a picnic be shared in association with the event.

The event theme and attribute suggester 130 may recommend themes and attributes for the event based on the information provided in the full event description 110. For example, an event titled “Jenny's birthday party” may have several invitees who are interested in 1980s music and fashion. As a result, a 1980s theme may be suggested for the event and a playlist including music from the 1980s may be suggested for the event.

The information generated by the entity and object creation module 120 is provided to a social networking service user interface (SNS) 134 for presentation to the end-user 138 (e.g., the event creator or a user authorized to edit the event by the event creator). The information may be modified, approved, or disapproved by, e.g., social networking service operators 136. The end-user 138 may modify, approve or disapprove of the information and allow or disallow the information to be posted to a page associated with the event in the social networking service or an event management service, or otherwise provided to other users of the social networking service or event management service(e.g., invitees to or attendees of the event). No information generated by the entity and object creation module 120 is posted to the social networking service without the approval of the end-user 138.

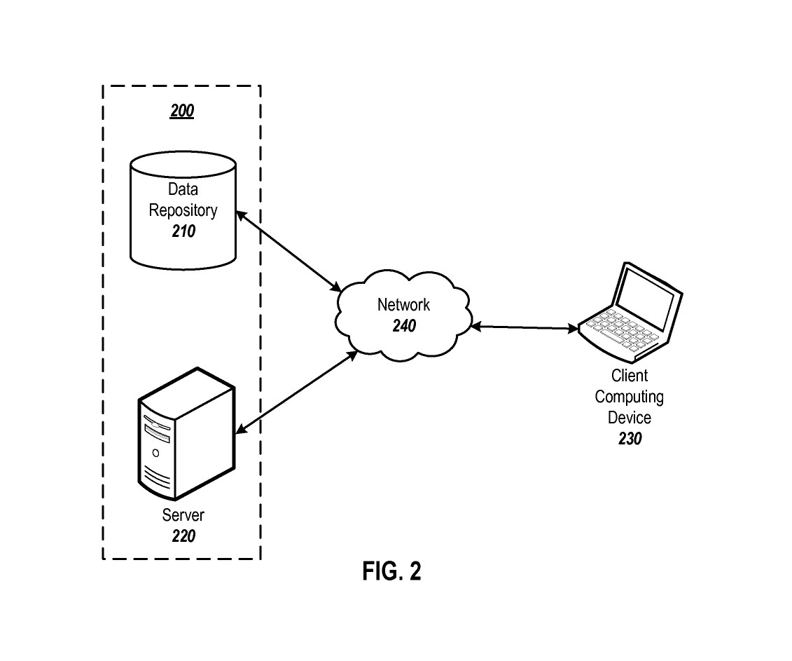

FIG. 2 illustrates an example of a system 200 for event-based entity and object creation. As shown, the system 200 includes a data repository 210 and a server 220. The data repository 210 and the server 220 communicate with one another and with and a client computing device 230 via a network 240. The network 240 may include the Internet, an intranet, a local area network, a wide area network, a wired network, a wireless network, or a virtual private network (VPN). While only one data repository 210, server 220, and client computing device 230 are illustrated, the subject technology may be implemented in conjunction with any number of data repositories 210, servers 220, or client computing devices 230. In some aspects, a single machine may implement the functions of two or more of the data repository 210, the server 220, or the client computing device 230.

The data repository 210 stores social content. Social content can include any content stored via a social networking service or event management service (e.g., websites or application for managing events), for example, event metadata, user profiles, and interest profiles for users. One example of the data repository 210 is described in more detail in conjunction with FIG. 3 below. Data repository 210 may be a single machine, multiple machines in a single location, or multiple machines distributed amongst various locations or any other combination of computing machines that support storage of data for a social networking service or event management service.

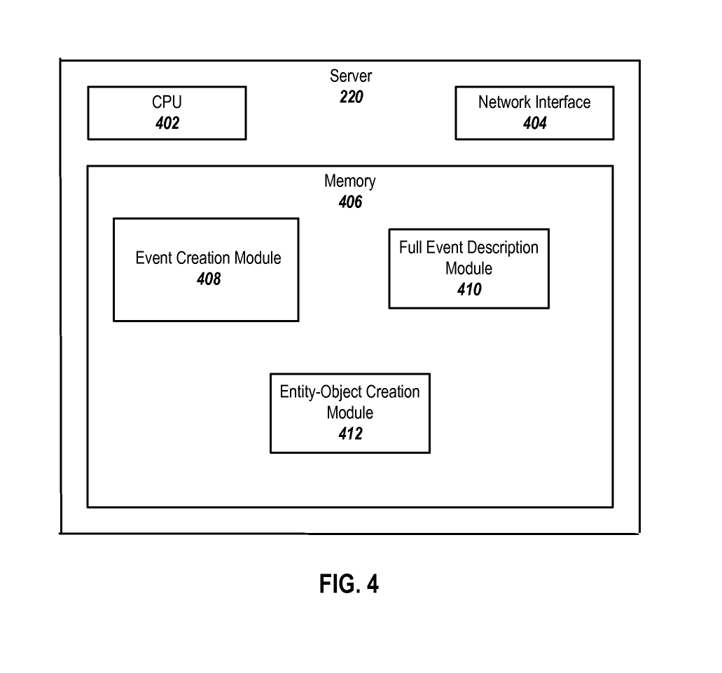

The server 220 includes one or more modules for facilitating user interaction with the social networking service or event management service via a browser or a special purpose application executing on the client computing device 230. The server 220 may be implemented as a single machine with a single processor, a multi-processor machine, or a server farm including multiple machines with multiple processors. One example of the server 220 is described in more detail in conjunction with FIG. 4 below.

The client computing device 230 may be a laptop computer, a desktop computer, a mobile phone, a personal digital assistant (PDA), a tablet computer, a netbook, a television with one or more processors embedded therein or coupled thereto, a physical machine, or a virtual machine. The client computing device 230 may include one or more of a keyboard, a mouse, a display, or a touch screen. The client computing device 230 may also include a web browser configured to display webpages, for example a webpage of the social networking service or the event management service. Alternatively, the client computing device 230 may include a special-purpose application (e.g., a mobile phone or tablet computer application) for accessing the social networking service or the event management service.

FIG. 3 illustrates an example of the data repository 210 of FIG. 2. As shown, the data repository 210 includes a central processing unit (CPU) 302, a network interface 304, and a memory 306. The CPU 302 includes one or more processors. The CPU 302 is configured to execute computer instructions that are stored in a computer-readable medium, for example, the memory 306. The network interface 304 is configured to allow the data repository 210 to transmit and receive data in a network, e.g., network 240 of FIG. 2. The network interface 304 may include one or more network interface cards (NICs). The memory 306 stores data or instructions. The memory 306 may be one or more of a cache unit, a storage unit, an internal memory unit, or an external memory unit. As illustrated, the memory 306 includes event metadata 308, user profiles 310, interest profiles 312, content items 320, news items 322, and op-ed items 324.

Event metadata 308 may include data about a subject, description, list of invitees/attendees, dates of the event, etc. User profiles 310 may include data on user information, e.g., the age, gender, birthday, city of residence, etc. about the user. The interest profiles 312 may include data about interests of the user (e.g., a list of interests of a user as provided by the user to the social networking service or determined by the social networking service based on the interactions of the user with the social networking service or determined by web usage history of the user or members of social groups of the user). For example, interest profiles may maintain a list of keywords that indicate topics or entities that are of interest to the user. The particular keywords may have a strength associated with it that indicates how strong the user's interest is in the particular topic or entity.

Content items 320 may include any number of data items, indexed by an entity or topic or keyword. For example, as discussed above for the agenda suggester 122, content items 320 may include events (e.g., football games information, concerts, movies, etc.), places (e.g., restaurants, museums, parks, etc.), things (e.g., images, documents, articles, etc.), or event theme items (e.g., images for the event, music for event, etc.), or any other content item that are relevant or related to the entity or topic of the index. News items 322 may be indexed on an entity or topic or keyword (e.g., “election 2012”, “java conference”, etc.). News items 322 may include articles, images, videos, audio, etc. content items that are relevant or related to the entity or topic of the index. Op-ed items 324 may be indexed on an entity or topic or keyword (e.g., “election 2012”, “java conference”, etc.). Op-ed items 324 may include articles, images, videos, audio, blogs, posts, etc. content items that are relevant or related to the entity or topic of the index, and are commentary on the entity or topic of the index.

In various aspects, event metadata 308, user profiles 310, and interest profiles 312 are analyzed to determine a set of entities, topics, or keywords for an event. Content items 320, news items 322, or op-ed items 324 may be queried based on the determined set of entities, topics or keywords to retrieve content items for suggesting an agenda (e.g., by agenda suggester 122), or to retrieve content items for newsletter subscription recommendations (e.g., by newsletter subscriber 124), or to retrieve content items for content to share recommendations (e.g., by content to share recommender 128), or for event theme suggestions (e.g., by event theme and attributes suggester 130). The set of entities, topics, or keywords to use for querying for content items 320, news items 322, or op-ed items 324 may be based on a threshold value of invitees/attendees indicating an interest in the corresponding entity, topic, or keywords.

In various aspects, event metadata 308 (e.g., the invitees/attendees list) is analyzed to make suggestions for a social group (e.g., by social group creator 108).

FIG. 4 illustrates an example of the server 220 of FIG. 2. As shown, the server 220 includes a central processing unit (CPU) 402, a network interface 404, and a memory 406. The CPU 402 includes one or more processors. The CPU 402 is configured to execute computer instructions that are stored in a computer-readable medium, for example, the memory 406. The network interface 404 is configured to allow the server to transmit and receive data in a network, e.g., network 240 of FIG. 2. The network interface 404 may include one or more network interface cards (NICs). The memory 406 stores data or instructions. The memory 406 may be one or more of a cache unit, a storage unit, an internal memory unit, or an external memory unit. As illustrated, the memory 406 includes an event creation module 408, a full event description module 410, and an entity-object creation module 412.

Event creation module 408 is configured to facilitate the creation of an event. For example, event creation module 408 may provide a user interface for display in a social networking service or an event management service for a user to create an event. The user interface allows the event creator to provide event metadata 308 for the creation of an event. Event creation module 408 is configured to receive event metadata provided by the event creator and provide it to data repository 210 or to the full event description module 410. Event metadata may include a subject, description, dates of the event, and a list of invitees/attendees of the event.

Event creation module 408 is also configured to take a list of the invitees/attendees and suggest a social group to be created for the group of invitees/attendees. Event creation module 408 may provide the suggestion for the social group to a social networking service, where a user may then either approve, disapprove, or modify the suggested social group.

Full event description module 410 is configured to receive event metadata 308 from event creation module 408 or to retrieve it from data repository 210. Full event description module 410 is also configured to retrieve user profiles 310 and interest profiles 312 from data repository 306. Full event description module 410 analyzes the event metadata 308, user profiles 310 and interest profiles 312 (as discussed for FIG. 1 above in more details) to create a full event description 110. The full event description 110, e.g., may include relevant meta-data 106, as determined based on event metadata 308, and interest set 118, as determined based on user profiles 310 and interest profiles 312. The full event description 110 is communicated to entity-object creation module 412 by the full event description module 410. In some aspects, full event description module 410 analyzes the event metadata 308 and creates a full event description 110 that is then communicated to the entity-object creation module 412, containing only relevant event meta data 308.

Entity-object creation module 412 is configured to receive full event description 110 from full event description module 410. In some aspects, the full event description 110 contains information based on event metadata 308. In some aspects, the full event description 110 contains information about event metadata 308 and user profiles 112 or interest profiles 114. In some Entity-object creation module 412 analyzes the received full event description 110 to make agenda suggestions, newsletter subscription recommendations, follower suggestions, content to share suggestions, and event theme and attributes suggestions (as discussed above with reference to FIG. 1).

In some aspects, entity-object creation module 412 is configured to take the received full event description 110, e.g., using attribute values in the full event description 110, and determine a set of entities, or topics, or keywords that are of interest to the group of invitees/attendees. The determination of which entities, or topics or keywords that are of interest to the group of invitees/attendees may be based on a threshold number of invitees/attendees expressing interest in the respective entity, topic, or keyword as determined by their respective interest profile. For example, if the interest profiles of 10 out of 20 invitees/attendees indicate an interest in American football, then American football may be used as an entity to query for content items, news items, or op-ed items. In other aspects, the strength of interest in a particular entity, topic, or keyword by a respective invitee/attendee is taken into account when determining if it is of interest to the group of invitees/attendees. The determined set of entities, topics, or keywords that are of interest to the group of invitees/attendees is used to query data repository 210 for content items 320, news items 322, or op-ed items 324. The retrieved items may then be used to make suggestions or recommendations for the event or based on the event.

Entity-object creation module 412 may be configured to have sub-modules agenda suggester 122, newsletter subscriber 124, follower suggester 126, content to share recommender 128, and event theme and attributes suggester 130 as discussed in more details for FIG. 1. Entity-object creation module 412 is configured to provide any determined suggestions or recommendations, e.g., for agenda items, newsletter subscription items, follower suggestions, content to share recommendations, or event theme or attribute suggestions to event creation module 408.

Event creation module 408 may then forward the received suggestions or recommendations to a user interface, either in a social networking service or an event management service, for a user of the event management to either modify, approve, or disapprove any of the suggestions or recommendations. Event creation module 408 is also configured to receive any approval, disapprovals, or modifications of suggestions or recommendations provided to the user. The event creation module 408 is also configured to modify an event based on the received approval, disapproval, or modification of the provided suggestions or recommendations.

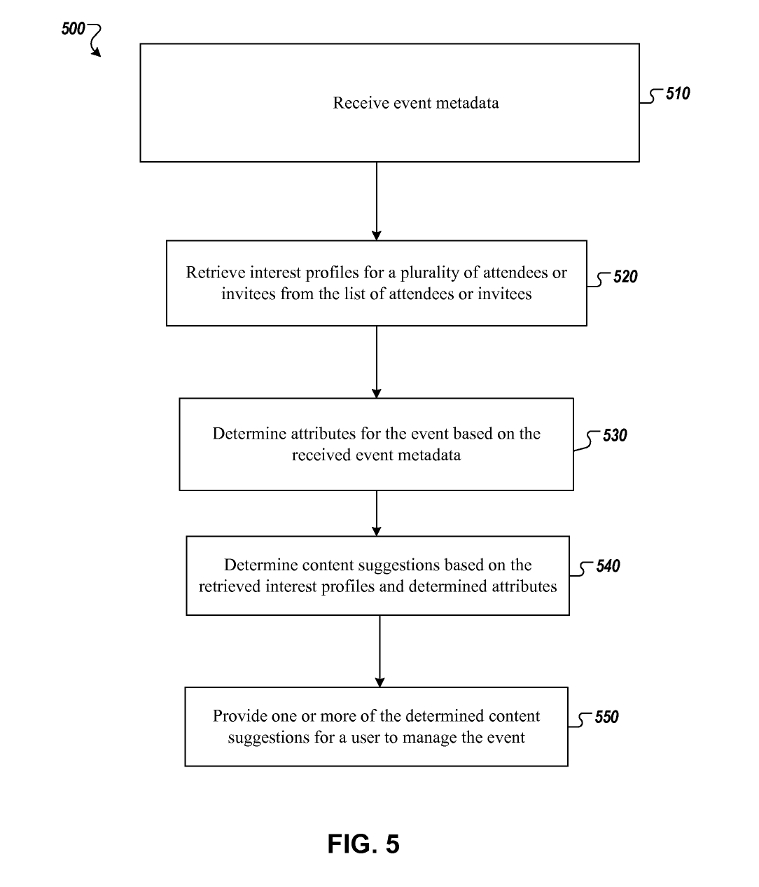

FIG. 5 illustrates an example process by which event-based entities and objects may be created. At step 510 event metadata is received. The event metadata may include a subject, a description, and a list of attendees or invitees for the event. The event metadata may be received based on an event created in a social networking service or an event management service. The received event metadata may include other information, e.g., dates of the event, etc.

At step 520, interest profiles for a plurality of attendees or invitees from the list of attendees or invitees are retrieved. Interest profiles may be retrieved, e.g., from data repository 210. Additionally, user profiles may also be retrieved for a plurality of attendees or invitees from the list of attendees or invitees are retrieved. The retrieved interest profiles or user profiles may be analyzed to determine an interest set 118, to include in a full event description 110 for use by entity-object creation module 412 in determining suggestions and recommendations for the event.

At step 530, attributes for the event are determined based on the received event metadata at step 510. In some aspects, full event description module 410 may receive event metadata 308 from event creation module 408 and determine attributes for the event based on the metadata 308 to include in a full event description 110. Attributes may include data such as the location, topic, dates of the event, etc., that pertain to the event.

At step 540, content suggestions are determined based on the retrieved interest profiles and determined attributes. In some aspects, entity-object creation module 412 receives relevant metadata and interest profiles, from step 530, and analyzes the data to determine suggestions and recommendations. In some aspects, entity-object creation module 412 may query data repository 210 for content items 320, or news items 322, or op-ed items 324 to provide as suggestions or recommendations for the event.

The content items 320, or news items 322, or op-ed items 324 may be queried based on entities, topics, or keywords provided by the relevant metadata or interest profiles. Retrieved content items 320 may be used to determine and construct an agenda to provide as a suggestion for the event. Retrieved content items 320 may be event themes or attributes, or content to share to recommend for the event. Retrieved news items 322 or op-ed items 324 may be provided as a suggestion in a newsletter subscription.

At step 550, one or more of the determined content suggestions are provided for a user to manage the event. The content suggestions may be provided to the user via either a social networking service or an event management service. The content suggestion may be either an agenda suggestion for the event, or a newsletter subscription for the event, or content to share for the event, or event themes to use in creating the event. The user may either modify a suggestion or recommendation, or may approve or may disapprove a suggestion or recommendation. Approval of a suggestion or recommendation may lead to a modification of the event. For example, if the suggestion was for an event theme, then the theme may be applied to the event. As another example, if the suggestion is for an agenda for the event, then the agenda may be added to the event.

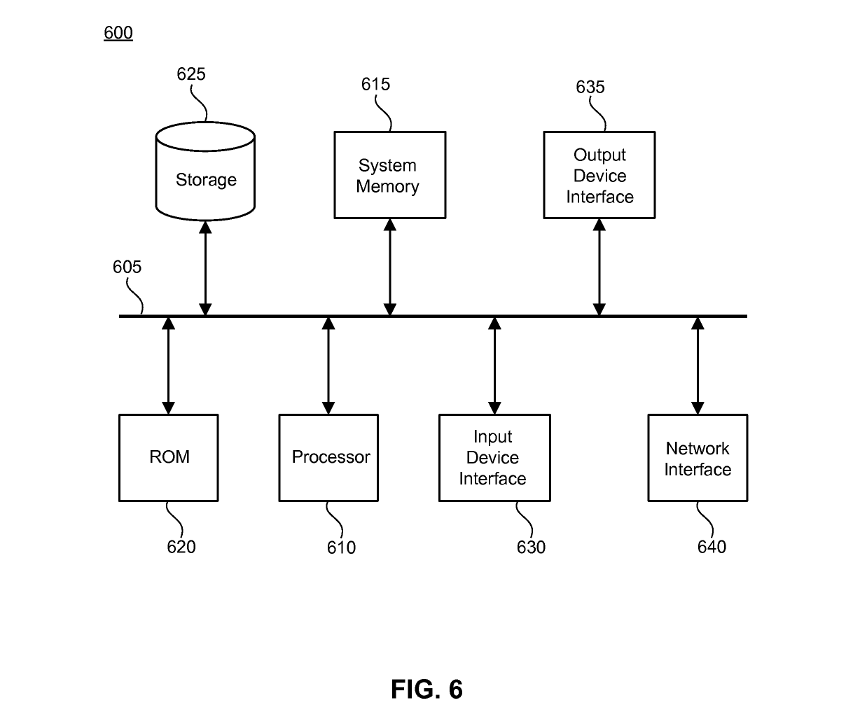

FIG. 6 conceptually illustrates an electronic system 600 with which some implementations of the subject technology are implemented. For example, one or more of the data repository 210, the server 220, or the client computing device 230 of FIG. 2 may be implemented using the arrangement of the electronic system 600. The electronic system 600 can be a computer (e.g., a mobile phone, PDA), or any other sort of electronic device. Such an electronic system includes various types of computer readable media and interfaces for various other types of computer readable media. Electronic system 600 includes a bus 605, processing unit(s) 610, a system memory 615, a read-only memory 620, a permanent storage device 625, an input device interface 630, an output device interface 635, and a network interface 640.

The bus 605 collectively represents all system, peripheral, and chipset buses that communicatively connect the numerous internal devices of the electronic system 600. For instance, the bus 605 communicatively connects the processing unit(s) 610 with the read-only memory 620, the system memory 615, and the permanent storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some implementations of the subject technology use a mass-storage device (for example a magnetic or optical disk and its corresponding disk drive) as the permanent storage device 625.

Other implementations use a removable storage device (for example a floppy disk, flash drive, and its corresponding disk drive) as the permanent storage device 625. Like the permanent storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the processes of the subject technology are stored in the system memory 615, the permanent storage device 625, or the read-only memory 620. For example, the various memory units include instructions for making suggestions or recommendations for an event or based on an event or user or interest profiles in accordance with some implementations. From these various memory units, the processing unit(s) 610 retrieves instructions to execute and data to process in order to execute the processes of some implementations.

The bus 605 also connects to the input and output device interfaces 630 and 635. The input device interface 630 enables the user to communicate information and select commands to the electronic system. Input devices used with input device interface 630 include, for example, alphanumeric keyboards and pointing devices (also called “cursor control devices”). Output device interfaces 635 enables, for example, the display of images generated by the electronic system 600. Output devices used with output device interface 635 include, for example, printers and display devices, for example cathode ray tubes (CRT) or liquid crystal displays (LCD). Some implementations include devices for example a touchscreen that functions as both input and output devices.

Finally, as shown in FIG. 6, bus 605 also couples electronic system 600 to a network (not shown) through a network interface 640. In this manner, the electronic system 600 can be a part of a network of computers (for example a local area network (“LAN”), a wide area network (“WAN”), or an Intranet, or a network of networks, for example the Internet. Any or all components of electronic system 600 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

The detailed description set forth is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may not be required and may not be executed. Some of the steps may be performed in an order different than illustrated. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A computer-implemented method, the method comprising:
receiving event metadata for an event;
retrieving interest profiles for a plurality of attendees or invitees of the event;
determining attributes for the event based on the received event metadata;
determining whether a number of attendees or invitees of the plurality of attendees or invitees indicating an interest in a particular item exceeds a predetermined threshold number based on information from the retrieved interest profiles;
identifying a shared interest in the particular item when the number of attendees or invitees exceeds the predetermined threshold number;
determining content suggestions based on the identified shared interest and the determined attributes;
modifying the event metadata using the determined content suggestions; and
providing the modified event metadata for a user to share the determined content suggestions with one or more of the plurality of attendees or invitees.

2. The method of claim 1, wherein the event metadata includes a subject, a description, and a list of attendees or invitees of the event.

3. The method of claim 1, further comprising:
retrieving user profiles for the plurality of attendees or invitees of the event; and
wherein determining content suggestions is further based on the retrieved user profiles.

4. The method of claim 1, further comprising:
constructing an agenda for the event based on the determined content suggestions; and
providing the constructed agenda for the user as a suggestion for the event.

5. The method of claim 1, further comprising:
constructing a newsletter for the event based on the determined content suggestions; and
providing the constructed newsletter for the user as a suggestion for the event.

6. The method of claim 1, wherein the determined content suggestions comprise of an event theme to use for the event.

7. The method of claim 1, wherein the determined content suggestions comprise of a content item associated with the event to share with one or more of the plurality of attendees or invitees of the event.

8. The method of claim 1, further comprising:
receiving indication of approval by the user of the one or more provided content suggestions; and
modifying the event based on the received indication of approval.

9. The method of claim 1, further comprising:
receiving indication of disapproval by the user of the provided content suggestions.

10. The method of claim 1, further comprising:
receiving indication of a modification by the user of the provided content suggestions; and
modifying the event based on the received indication of the modification.

11. A computer-readable medium storing instructions that when executed cause a computer to perform operations, the operations comprising:
receiving event metadata for an event;
retrieving user profiles and interest profiles for a plurality of attendees or invitees of the event;
determining attributes for the event based on the received event metadata;
determining whether a number of attendees or invitees of the plurality of attendees or invitees indicating an interest in a particular item exceeds a predetermined threshold number based on information from the retrieved interest profiles;
identifying a shared interest in the particular item when the number of attendees or invitees exceeds the predetermined threshold number;
determining content suggestions based on the identified shared interest and the determined attributes;
modifying the event metadata using the determined content suggestions; and
providing the modified event metadata for a user to manage the event with the determined content suggestions.

12. The computer-readable medium of claim 11, the operations further comprising:
constructing an agenda for the event based on the determined content suggestions; and
providing the constructed agenda for the user as a suggestion for the event.

13. The computer-readable medium of claim 11, the operations further comprising:
constructing a newsletter for the event based on the determined content suggestions; and
providing the constructed newsletter for the user as a suggestion for the event.

14. The computer-readable medium of claim 11, wherein the determined content suggestions comprise of an event theme to use for the event.

15. The computer-readable medium of claim 11, wherein the determined content suggestions comprise a content item associated with the event to share with one or more of the plurality of attendees or invitees of the event.

16. The computer-readable medium of claim 11, the operations further comprising:
receiving indication of approval by the user of the one or more provided content suggestions; and
modifying the event based on the received indication of approval.

17. The computer-readable medium of claim 11, the operations further comprising:
receiving indication of disapproval by the user of the one or more provided content suggestions.

18. The computer-readable medium of claim 11, the operations further comprising:
receiving indication of a modification from the user of the provided content suggestions; and
modifying the event based on the received indication of the modification.

19. A computer-implemented system, the system comprising:
one or more processors;
a memory comprising instructions which, when executed by the one or more processors, cause the one or more processors to:
receive event metadata for an event;
retrieve interest profiles for a plurality of attendees or invitees from the list of attendees or invitees;
determine attributes for the event based on the received event metadata;
determine whether a number of attendees or invitees of the plurality of attendees or invitees indicating an interest in a particular item exceeds a predetermined threshold number based on information from the retrieved interest profiles;
identify a shared interest in the particular item when the number of attendees or invitees exceeds the predetermined threshold number;
determine content suggestions based on the determined attributes and the retrieved interest profiles;
modifying the event metadata using the determined content suggestions; and
provide the modified event metadata for a user to manage the event with the determined content suggestions.

20. (canceled)

21. The computer-implemented system of claim 19, further comprising instructions that cause the one or more processors to:
receive indication of approval by the user of the one or more provided content suggestions; and
modify the event based on the received indication of approval.
